(19) United States
(12) Patent Application Publication
(10) Pub. No.: US 2006/0251460 A1
(43) Pub. Date: Nov. 9, 2006

(54) PRINTER AND PAPER TRANSPORT DEVICE THEREOF

(75) Inventor: Ying-Hsien Kuo, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/381,363

(22) Filed: May 3, 2006

(30) Foreign Application Priority Data
May 5, 2005 (TW) 94114560

(51) Int. Cl. B41J 11/02; B41J 11/08

(52) U.S. Cl. 400/656

(57) ABSTRACT

A printer and a paper transport device thereof are provided. The paper transport device comprises a printing platen, a feed roller, several exit rollers and several hydrophobic rollers. The printing platen has an arc surface. The feed roller is disposed on a first side of the printing platen for transporting a paper to the printing platen. The exit rollers are separately disposed on a second side of the printing platen. The hydrophobic rollers are correspondingly disposed above the exit rollers. The hydrophobic rollers clip the paper with the exit rollers, and rotate synchronously with the exit rollers to transport the paper out of the printing platen.

This application claims the benefit of Taiwan application Serial No. 94114560, filed May 5, 2005, the subject matter of which is incorporated herein by reference.

### BACKGROND OF THE INVENTION

1. Field of the Invention

The invention relates in general to a printer and a paper transport device thereof, and more particularly to a printer and a paper transport device capable of full width printing and preventing from paper cockling.

2. Description of the Related Art

Generally speaking, as a printing apparatus needs to print large amount of papers or perform high-resolution printing using an ink jetting method, ink is often piled up in a printed area on a paper. The piled ink then interacts with the paper because of the fiber character of the paper. Therefore, the paper is bent downward along the outputting direction. The phenomenon is called a “cockling effect”. Seriously, the “cockling effect” will be lasted in the next printed area on the paper, and make the distance between a print head of the ink cartridge and the paper decreasing or increasing. If the distance between the print head and the paper can not keep a constant, the place that the ink drops on will be changed. Thus, a light and shade band is usually generated on the printed image of the paper and the printing quality is downgraded.

For eliminating the above-mentioned problem of cockling effect, a conventional method is using the reverse-curve character of the paper to overcome the cockling effect. Reference is made to FIG. 1, which depicts a perspective view showing prior paper transport device with a cockle rib. A paper transport device 100 includes a drive roller 102 and a supporting platen 104. The drive roller 102 is used for transporting a paper 108 to the supporting platen 104. Several cockle ribs 106 are disposed on the supporting platen 104 and parallel to the transport direction. When the paper transport device 100 transports the paper 108, a first bending fringe 110 and a second bending fringe 112 may form on the paper 108. The first bending fringe 110 includes a series of cockling lines. The second bending fringe 112 is a continuous-wave shape. When the rear end of the paper 108 departs from the drive roller 102, the drive roller 102 could not drive the paper 108 smoothly because of the first bending fringe 110 and the second bending fringe 112, so that the prior printing apparatus can not print the whole page 108.

### SUMMARY OF THE INVENTION

It is an aspect of the present invention to provide a printer and a paper transport device thereof. The paper transport device includes several hydrophobic rollers, which are arranged in an arc shape. The arrangement of the hydrophobic rollers could increase the ability of preventing from paper cockling.

According to the aforementioned aspect of the present invention, a paper transport device is provided. The paper transport device comprises a printing platen, a feed roller, several exit rollers and several hydrophobic rollers. The printing platen has an arc surface. The feed roller is disposed on a first side of the printing platen for transporting a paper to the printing platen. The exit rollers are separately disposed on a second side of the printing platen. The hydrophobic rollers are correspondingly disposed above the exit rollers. The hydrophobic rollers co-work with the exit rollers to clip the paper, and rotate synchronously with the exit rollers to transport the paper out of the printing platen.

According to the aforementioned aspect of the present invention, a printer is provided. The printer comprises a print head and a paper transport device. The paper transport device is disposed under the print head. The paper transport device comprises a printing platen, a feed roller, several exit rollers and several hydrophobic rollers. The printing platen has an arc surface. The feed roller is disposed on a first side of the printing platen for transporting a paper to the printing platen. The exit rollers are separately disposed on a second side of the printing platen. The hydrophobic rollers are correspondingly disposed above the exit rollers. The hydrophobic rollers co-work with the exit rollers to clip the paper, and rotate synchronously with the exit rollers to transport the paper out of the printing platen.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) depicts a perspective view showing prior paper transport device with a cockle rib;

FIG. 2A depicts a cross-section view showing a printer in accordance with the first preferred embodiment of the present invention;

FIG. 2B depicts a cross-section view showing roller arrangement of the printer in accordance with the first preferred embodiment of the present invention;

FIG. 3 depicts a perspective view showing a paper subjected to a force in accordance with the FIG. 2A of the present invention;

FIG. 4A depicts a cross-section view showing a printer in accordance with the second preferred embodiment of the present invention;

FIG. 4B depicts a cross-section view showing roller arrangement of the printer in accordance with the second preferred embodiment of the present invention; and

FIG. 5 depicts a perspective view showing a paper subjected to a force in accordance with FIG. 4A of the present invention.

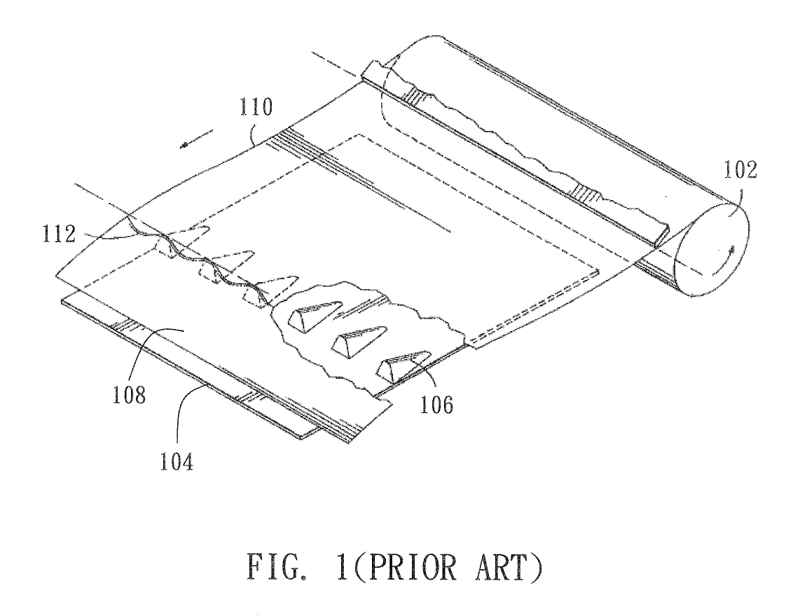

### DETAILED DESCRIPTION OF THE INVENTION

### First Embodiment

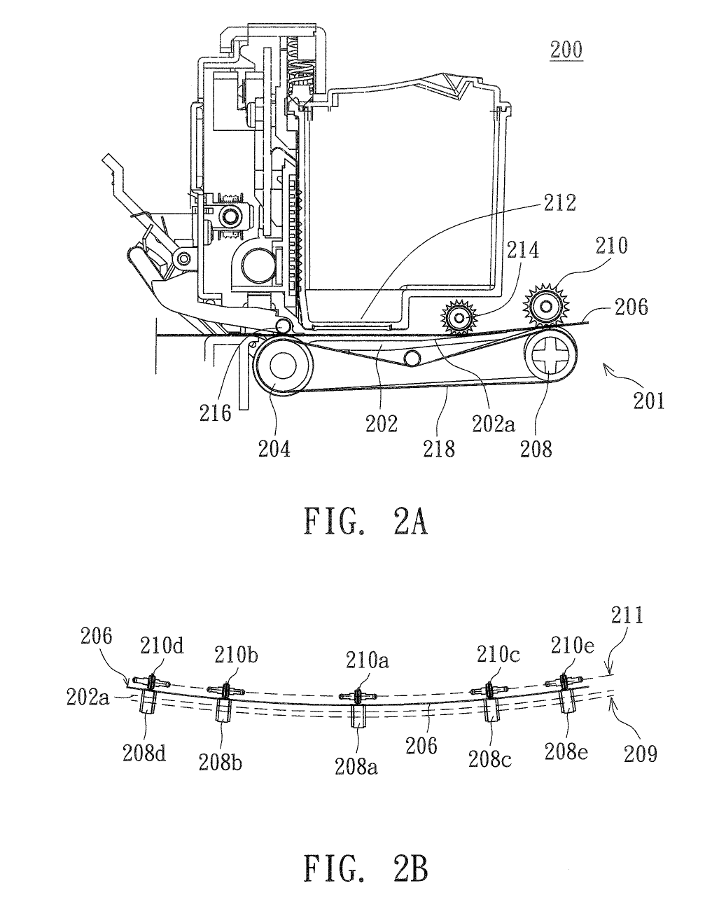

Reference is made to FIGS. 2A-2B, FIG. 2A depicts a cross-section view showing a printer in accordance with the first preferred embodiment of the present invention, and FIG. 2B depicts a cross-section view showing roller arrangement of the printer in accordance with the first preferred embodiment of the present invention. The printer 200 comprises a print head 212 and a paper transport device 201. The paper transport device 201 is disposed under the print head 212. The paper transport device 201 includes a printing platen 202, a feed roller 204, several exit rollers 208 and several hydrophobic rollers 210, such as several star wheels 210, as shown in FIG. 2A. Furthermore, the printing platen 202 includes an arc surface 202a. The feed roller 204 is disposed on a first side of the printing platen 202 for transporting a paper 206 to the arc surface 202a of the printing platen 202 for ink jet printing. The exit rollers 208 are separately disposed on a second side of the printing platen 202. The second side of the printing platen 202 is opposite to the first side of the printing platen 202. The exit rollers 208 are arranged parallel to the arc surface 202a. That is, the axle center of the exit rollers 208 could be linked together to form a first arc 209. The first arc 209 is substantially parallel to the arc surface 202a. For example, there are five exit rollers 208 described in the first embodiment of the present invention, such as a first exit roller 208a, a second exit roller 208b, a third exit roller 208c, a fourth exit roller 208d and a fifth exit roller 208e.

Furthermore, the exit rollers 208 correspond to the hydrophobic rollers 210. For example, a first star wheel 210a is disposed above the first exit roller 208a, a second star wheel 210b is disposed above the second exit roller 208b, a third star wheel 210c is disposed above the third exit roller 208c, a fourth star wheel 210d is disposed above the fourth exit roller 208d, and a fifth star wheel 210e is disposed above the fifth exit roller 208e. The axle centers of the first star wheel 210a, the second star wheel 210b, the third star wheel 210c, the fourth star wheel 210d and the fifth star wheel 210e could be linked together to form a second arc 211. The second arc 211 is substantially parallel to the first arc 209 and the arc surface 202a. In addition, the first star wheel 210a and the first exit roller 208a co-work to clip the paper 206. The second star wheel 210b and the second exit roller 208b co-work to clip the paper 206. The third star wheel 210c and the third exit roller 208c co-work to clip the paper 206. The fourth star wheel 210d and the fourth exit roller 208d co-work to clip the paper 206. And the fifth star wheel 210e and the fifth exit roller 208e co-work to clip the paper 206, so that the paper 206 could be substantially parallel to the arc surface 202a. Furthermore, the first star wheel 210a, the second star wheel 210b, the third star wheel 210c, the fourth exit roller 208d and the fifth star wheel 210e could rotate synchronously with the first exit roller 208a, the second exit roller 208b, the third exit roller 208c, the fourth exit roller 208d and the fifth exit roller 208e to transport the paper 206 out of the printing platen 202. As described in the present embodiment of the invention, the arc surface 202a is preferably concave upward, the first arc 209 and the second arc 211 are preferably concave upward, and the paper 206 is preferably concave upward.

As to the arrangement of the present embodiment of the invention, the first exit roller 208a is disposed between the second exit roller 208b and the third exit roller 208c. If the radii of the first exit roller 208a, the second exit roller 208b, the third exit roller 208c, the fourth exit roller 208d and the fifth exit roller 208e are equal, the position of the axle center of the first exit roller 208a is lower than the positions of the axle centers of the second exit roller 208b and the third exit roller 208c. As the same, the position of the axle center of the fourth exit roller 208d is higher than the position of the axle center of the second exit roller 208b. The position of the axle center of the fifth exit roller 208e is higher than the position of the axle center of the third exit roller 208c. The above-mentioned arrangement of the first exit roller 208a, the second exit roller 208b, the third exit roller 208c, the fourth exit roller 208d and the fifth exit roller 208e could form the first arc 209 which is concave upward.

Furthermore, the arrangement of the hydrophobic rollers 210 corresponding to the exit rollers 208 is the same as the arc arrangement of the exit rollers 208. If the radii of the first star wheel 210a, the second star wheel 210b, the third star wheel 210c, the fourth exit roller 208d and the fifth star wheel 210e are equal, the position of the axle center of the first star wheel 210a is lower than the positions of the axle centers of the second star wheel 210b and the third star wheel 210c. As the same, the position of the axle center of the fourth exit roller 208d is higher than the position of the axle center of the second star wheel 210b. The position of the axle center of the fifth star wheel 210e is higher than the position of the axle center of the third star wheel 210c. Therefore, the above-mentioned arrangement of the first star wheel 210a, the second star wheel 210b, the third star wheel 210c, the fourth exit roller 208d and the fifth star wheel 210e could form the second arc 211 which is concave upward.

As the hydrophobic rollers 210 could rotate synchronously with the exit rollers 208, the paper 206 could be carried away from the printing platen 202 smoothly and form a paper which is concave upward. Since the paper 206 is concave upward, a stress could be generated in the paper 206, which provides the ability of avoiding cockling effect. Therefore, the problem of cockling effect could be eliminated.

As described in the present embodiment of the invention, the paper transport device 201 further includes at least a pressing roller, such as a pressing star wheel 214, as shown in FIG. 2A. The pressing star wheel 214 is disposed on the printing platen 202. The pressing star wheel 214 is disposed between the print head 212 and the hydrophobic rollers 210. The pressing star wheel 214 is used for transporting and pressing the paper 206, so that the paper 206 could lean on the arc surface 202a. When the rear end of the paper 206 departs from the feed roller 204, the pressing star wheel 214 could transport the paper 206 continuously, so that the printer 200 of the present invention is capable of whole page printing (full width printing) of the page 206. In addition, the paper 206 could lean on the arc surface 202a, so that the paper 206 has a stress for avoiding cockle effect and the place where the ink drops is very fixed and not changed.

Furthermore, the paper transport device 201 further includes several flexible linking components, such as several belts 218. The belts 218 are sleeved on the feed roller 204 and the exit rollers 208, so that the feed roller 204 and the exit rollers 208 could rotate synchronously. The feed roller 204 may be a driving roller, and the exit rollers 208 may be following rollers. On the other, the exit rollers 208 could be driving rollers, and the feed roller 204 could be a following roller. In addition, the paper transport device 201 further includes a clipping roller 216. The clipping roller 216 is rotatably disposed above the feed roller 204. The clipping roller 216 could co-work with the feed roller 204 for clipping the paper 206. Since the clipping roller 216 could rotate synchronously with the feed roller 204, the paper 206 could be transported to the printing platen 202 smoothly and efficiently.

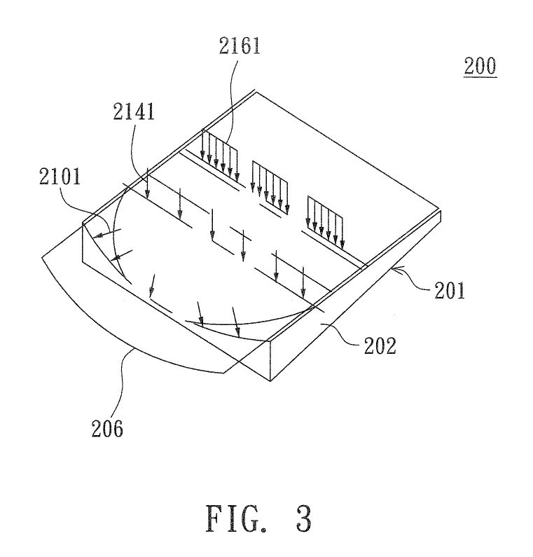

Reference is made to FIG. 3, which depicts a perspective view showing a paper subjected to a force in accordance with the FIG. 2A of the present invention. A clipping roller pressing force 2161 from the clipping roller 216 is pressed downward on the paper 206, as shown in FIG. 3, so that the paper 206 is transported to the printing platen 202 smoothly. As the arrangement of the hydrophobic rollers 210 and the exit rollers 208, the paper 206 could be concave upward because of a hydrophobic roller pressing force 2101 while the paper 206 is transported to a place between the hydrophobic rollers 210 and the exit rollers 208, as shown in FIG. 2A. Then, an inner stress is generated in the paper 206. Thus, the ability of avoiding cockle effect for the paper 206 increases because of the arc arrangement of the hydrophobic rollers 210 and the exit rollers 208. Therefore, the paper transport device 201 of the present embodiment of the invention could improve the ability of avoiding cockle effect for the paper, and could further make the printer 200 capable of full width printing.

### Second Embodiment

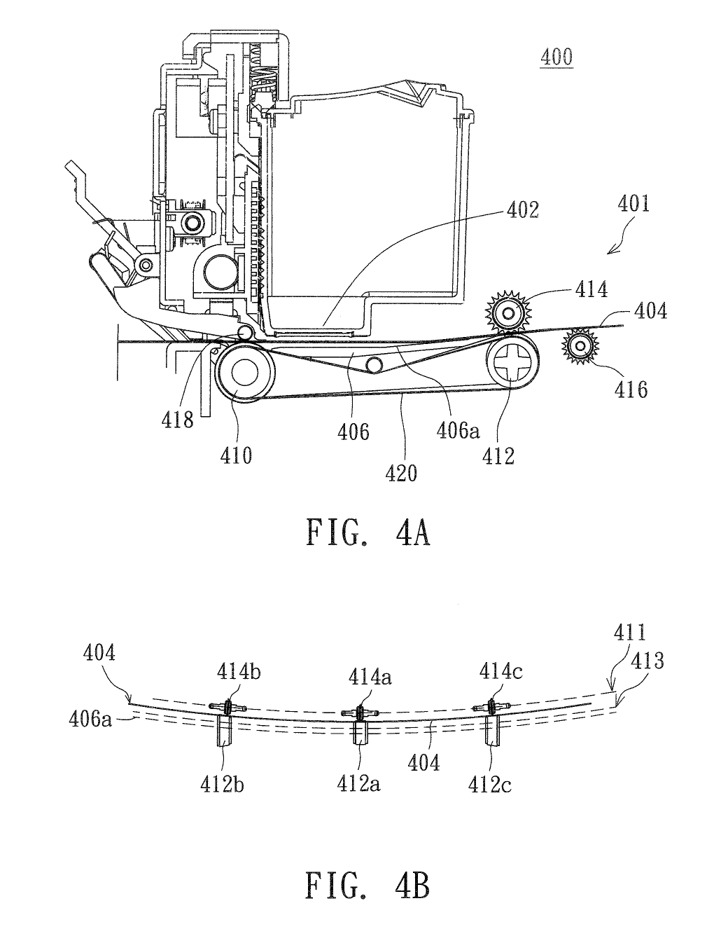

Reference is made to FIGS. 4A-4B, FIG. 4A depicts a cross-section view showing a printer in accordance with the second preferred embodiment of the present invention, and FIG. 4B depicts a cross-section view showing roller arrangement of the printer in accordance with the second preferred embodiment of the present invention. The printer 400 comprises a print head 402 and a paper transport device 401. The print head 402 is used for ink jet printing on a paper 404. The paper transport device 401 is disposed under the print head 402. The paper transport device 401 includes a printing platen 406, a feed roller 410, several exit rollers 412 and several hydrophobic rollers 414. Furthermore, the printing platen 406 includes an arc surface 406a. The feed roller 410 is disposed on a first side of the printing platen 406 for transporting a paper 404 to the arc surface 406a of the printing platen 406 for ink jet printing from the print head 402. The exit rollers 412 are separately disposed on a second side of the printing platen 406. The second side of the printing platen 406 is opposite to the first side of the printing platen 406. The exit rollers 412 are parallel to each other and correspond to the arc surface 406a. The axle centers of the exit rollers 412 could be linked together to form a first arc 413. The first arc 413 is substantially parallel to the arc surface 406a. For example, there are three exit rollers 412 described in the present embodiment of the invention, such as a first exit roller 412a, a second exit roller 412b, and a third exit roller 412c.

Furthermore, the hydrophobic rollers 414 correspond to the exit rollers 412. For example, a first star wheel 414a, a second star wheel 414b, and a third star wheel 414c are correspondingly disposed above the first exit roller 412a, the second exit roller 412b, and the third exit roller 412c. The axle centers of the first star wheel 414a, the second star wheel 414b, and the third star wheel 414c are linked together to form a second arc 411. The second arc 411 is substantially parallel to the first arc 413 and the arc surface 406a. In addition, the first star wheel 414a and the first exit roller 412a co-work to clip the paper 404, the second star wheel 414b and the second exit roller 412b co-work to clip the paper 404, and the third star wheel 414c and the third exit roller 412c co-work to clip the paper 404, so that the paper 404 could be substantially parallel to the arc surface 406a. Furthermore, the first star wheel 414a, the second star wheel 414b, and the third star wheel 414c could rotate synchronously with the corresponding first exit roller 412a, the corresponding second exit roller 412b, and the corresponding third exit roller 412c, respectively, to transport the paper 404 out of the printing platen 406. In the present embodiment of the invention, the arc surface 406a is preferably concave upward, the first arc 413 is preferably concave upward, the second arc 411 is preferably concave upward, and the paper 404 is preferably concave upward.

As the arrangement of the present embodiment of the invention, the first exit roller 412a is disposed between the second exit roller 412b and the third exit roller 412c. If the radius of the first exit roller 412a is smaller than the radii of the second exit roller 412b and the third exit roller 412c, and the axle centers of the first exit roller 412a, the second exit roller 412b and the third exit roller 412c are linked together to form a horizontal line, the clipping edge of the first exit roller 412a is lower than the clipping edges of the second exit roller 412b and the third exit roller 412c.

Furthermore, the hydrophobic rollers 414 corresponding to the exit rollers 412 is arranged like the arc arrangement of the hydrophobic rollers 210 of the first embodiment, which is unnecessary described herein.

In the present embodiment of the invention, the paper transport device 401 further comprises a supporting roller, such as a supporting star wheel 416, as shown in FIG. 4A. The supporting roller 416 is disposed near to the second side of the printing platen 406 (behind the exit rollers 412), so that the hydrophobic rollers 414 are located between the supporting roller 416 and the feed roller 410. The supporting roller 416 is used for transporting the paper 404 and providing a supporting force for the paper 404, so that the paper 404 becomes a paper which is concave upward. In addition, the paper transport device 401 further comprises a clipping roller 418, which is rotatably disposed above the feed roller 410 and co-works with the feed roller 410 to clip the paper 404. The clipping roller 418 and the feed roller 410 rotate synchronously to transport the paper 404 to the printing platen 406 smoothly and precisely.

Furthermore, the paper transport device 401 further comprises several flexible linking components, such as belts 420, which are sleeved on the feed roller 410 and the exit rollers 412, so that the feed roller 410 and the exit rollers 412 could rotate synchronously. The exit rollers 412 are preferred driving rollers, and the feed roller 410 is preferred a following roller. Instead, the feed roller 410 could be a driving roller, and the exit rollers 412 could be following rollers.

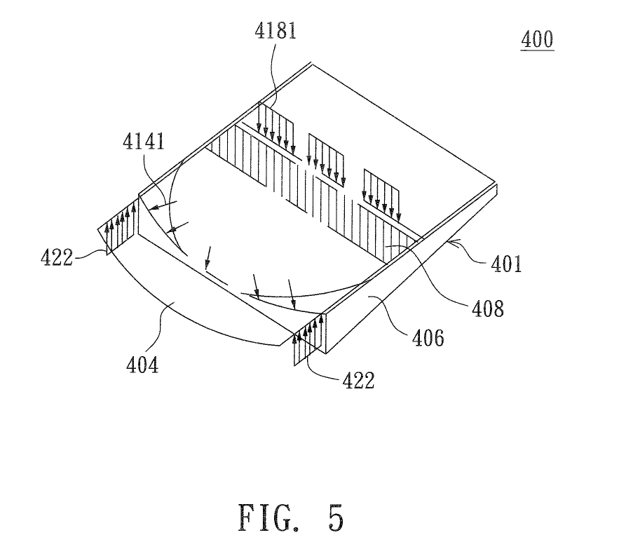

Reference is made to FIG. 5, which depicts a perspective view showing a paper subjected to a force in accordance with FIG. 4A of the present invention. A clipping roller pressing force 4181 from the clipping roller 418 is pressed downward on the paper 404, so that the paper 404 is transported to the printing platen 406 smoothly. A star wheel pressing force 4141 and a star wheel supporting force 422 co-work to keep the paper 404 to be concave upward. Since the paper 404 is concave upward, a stress could be generated in the paper 404, so that the ability of avoiding cockling effect of the paper 404 increases. In addition, since the exit rollers 412 remains moving, the printer 400 of the present embodiment of the invention is capable of full width printing while the rear end of the paper 404 departs from the feed roller 410.

As is understood by a person skilled in the art, the foregoing preferred embodiments of the present invention are illustrated of the present invention rather than limiting of the present invention. For example, the paper transport device 201 of the first embodiment of the invention could be disposed behind the exit rollers 208, so that the pressing roller 214 could be omitted. In addition, the paper transport device 401 of the second embodiment of the invention could be disposed between the feed roller 410 and the exit rollers 412, so that the supporting roller 416 could be omitted.

The paper transport device described in the preferred embodiments of the present invention uses the arc arrangement of the hydrophobic rollers to transport a paper, which improves the ability of avoiding cockling effect for the paper and the printer of the present invention is capable of full width printing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A paper transport device, comprising:
a printing platen having an arc surface;
a feed roller disposed on a first side of the printing platen for transporting a paper to the printing platen;
a plurality of exit rollers separately disposed on a second side of the printing platen; and
a plurality of hydrophobic rollers correspondingly disposed above the exit rollers, the hydrophobic rollers clipping the paper with the exit rollers, and the hydrophobic rollers rotating synchronously with the exit rollers to transport the paper out of the printing platen.

2. The paper transport device according to claim 1, wherein the exit rollers form a first arc, the hydrophobic rollers form a second arc, and the first arc and the second arc are substantially parallel to the arc surface.

3. The paper transport device according to claim 1, further comprising a pressing roller disposed on the printing platen for transporting and pressing the paper to lean on the arc surface.

4. The paper transport device according to claim 1, further comprising a supporting roller disposed near to the second side of the printing platen to locate the hydrophobic rollers between the supporting roller and the feed roller, wherein the supporting roller supports and transports the paper.

5. The paper transport device according to claim 1, further comprising a plurality of flexible linking components sleeved on the feed roller and the exit rollers, wherein the feed roller and the exit rollers rotate synchronously.

6. The paper transport device according to claim 5, wherein the feed roller is a driving roller, and the exit rollers are a plurality of following rollers.

7. The paper transport device according to claim 5, wherein the flexible linking components are a plurality of belts.

8. The paper transport device according to claim 4, wherein the hydrophobic rollers are a plurality of star wheels.

9. The paper transport device according to claim 1, wherein the arc surface is concave upward.

10. A printer, comprising:
a print head; and
a paper transport device disposed under the print head, comprising:
a printing platen having an arc surface;
a feed roller disposed on a first side of the printing platen for transporting a paper to the printing platen;
a plurality of exit rollers separately disposed on a second side of the printing platen; and
a plurality of hydrophobic rollers correspondingly disposed above the exit rollers, the hydrophobic rollers clipping the paper with the exit rollers, and the hydrophobic rollers rotating synchronously with the exit rollers to transport the paper out of the printing platen.

11. The printer according to claim 10, wherein the exit rollers form a first arc, the hydrophobic rollers form a second arc, and the first arc and the second arc are substantially parallel to the arc surface.

12. The printer according to claim 10, wherein the paper transport device further comprising a pressing roller disposed on the printing platen for transporting and pressing the paper to lean on the arc surface.

13. The printer according to claim 10, wherein the paper transport device further comprising a supporting roller disposed near to the second side of the printing platen to locate the hydrophobic rollers between the supporting roller and the feed roller, wherein the supporting roller supports and transports the paper.

14. The printer according to claim 10, wherein the paper transport device further comprising a plurality of flexible linking components sleeved on the feed roller and the exit rollers, wherein the feed roller and the exit rollers rotate synchronously.

15. The printer according to claim 14, wherein the feed roller is a driving roller, and the exit rollers are a plurality of following rollers.

16. The printer according to claim 14, wherein the flexible linking components are a plurality of belts.

17. The printer according to claim 10, wherein the hydrophobic rollers are a plurality of star wheels.

18. The printer according to claim 10, wherein the arc surface is an arc surface concave upward.
